(19) United States
(12) Patent Application Publication
(10) Pub. No.: US 2024/0196790 A1
(43) Pub. Date: Jun. 20, 2024

(54) Residue Chopper and Spreader Arrangement

(71) Applicant: AGCO International GmbH, Neuhausen (CH)

(72) Inventor: Thomas Smed Bojsen, Randers (DK)

(21) Appl. No.: 18/508,589

(22) Filed: Nov. 14, 2023

(30) Foreign Application Priority Data
Dec. 14, 2022 (GB) 2218828.8

(51) Int. Cl. A01D 41/12

(52) U.S. Cl. CPC A01D 41/1243

(57) ABSTRACT

A crop residue spreader arrangement is disclosed comprising a frame, a pair of counter rotating residue spreader wheels carried from the frame, a residue chopper comprising an inlet, an outlet and a plurality of chopping blades between the inlet and the outlet. The pair of counter rotating residue spreader wheels are arranged inclined to the with respect to the outlet of the residue chopper and the outlet of the residue chopper comprises an adjustable portion to set a feeding point of the crop residue from the residue chopper to the counter rotating residue spreader wheels.

### FIELD

The present invention relates to agricultural harvesters such as combine harvesters, and, more particularly, to a crop residue spreader arrangement for spreading crop residue over the ground behind the harvester.

### BACKGROUND

For many decades, self-propelled combine harvesters have been used by farmers to harvest a wide range of crops including cereals, maize and oil-seed rape. Typically, a combine harvester cuts the crop material, threshes the grain (or seed) therefrom, separates the grain from the straw, and cleans the grain before storing in an on-board tank. Straw and crop residue is ejected from the rear of the machine.

It is well known to fit combine harvesters with a cutting machine such as a straw chopper at the rear of the machine for chopping the straw ejected from the separating apparatus. Depending on the requirements of the farmer, the straw is either deposited directly onto the ground in windrows for subsequent baling and removal, or chopped and spread onto the field behind the combine for incorporation back into the soil. Means to direct the straw onto the ground typically comprises a tailboard or spreader arrangement incorporating a pair of counter rotating spreader wheels.

Variables such as the field's terrain, cutting height and wind direction can affect the final placement of the crop residue. Farmers want the spread width to be quickly and independently adjustable left to right whilst still maintaining an even distribution of straw and crop residue across the field.

It is an advantage of the present invention that consistent crop residue spreading is addressed. It is an object of the invention to provide even spread width together with side-to-side compensation without reducing the speed of the counter rotating spreader wheels.

### BRIEF SUMMARY

According to a first aspect of the present invention, a crop residue spreader arrangement comprises a frame, a pair of counter rotating residue spreader wheels carried from the frame, a residue chopper comprising an inlet, an outlet and a plurality of chopping blades between the inlet and the outlet, characterised in that the pair of counter rotating residue spreader wheels are arranged at a downwardly inclined angle with respect to the outlet of the residue chopper and in that the outlet of the residue chopper comprises an adjustable portion adjustable between a lowered position and a raised position to set a feeding point of the crop residue from the residue chopper to the counter rotating residue spreader wheels.

Preferably, the adjustable portion comprises independently operable left- and right-hand side portions to set feeding points of the crop residue from the residue chopper to each of the counter rotating residue spreader wheels.

According to a second aspect of the invention, an agricultural harvester comprises a chassis and a crop residue spreader arrangement according to the first aspect of the present invention carried by said chassis at a rear of the agricultural harvester.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The invention will now be described, by way of example only, with reference to the accompanying drawings, in which:

FIG. 1 shows a schematic side view of a known combine harvester comprising a residue spreader positioned after or downstream of a straw chopper;

FIG. 2 shows an enlarged schematic side view of a residue handling system located at the rear of a combine harvester in accordance with an embodiment; a schematic side view of a round baler and a towing vehicle;

FIG. 3 shows a schematic side view of a crop residue spreader arrangement;

FIG. 4 shows a first schematic view of the counter rotating residue spreader wheels illustrating a first flow of crop residue;

FIG. 5 shows a second schematic view of the counter rotating residue spreader wheels similar to FIG. 4 illustrating a second flow of crop residue;

FIG. 6 shows a schematic view of electronic elements of a first example of the crop residue spreader arrangement;

FIG. 7 shows a schematic view of electronic elements of a second example of the crop residue spreader arrangement.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

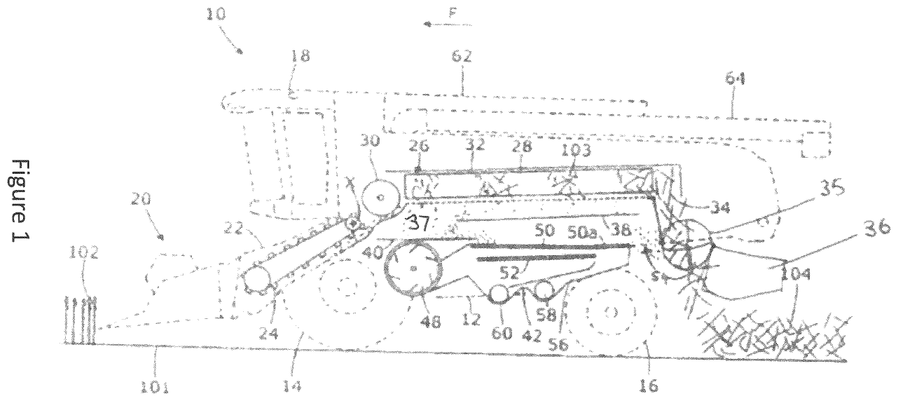

Relative terms such as forward, rearward, transverse, lateral, longitudinal, and sideways will be made with reference to the normal forward direction of travel of the combine 10 and indicated by arrow F represented in FIG. 1. The terms vertical and horizontal will be made with reference to the level ground 101 upon which the combine 10 is disposed. In other words, the Cartesian axes of ‘longitudinal’, ‘transverse’, and ‘vertical’ are made in relation to the chassis 12 of combine 10 and are not affected by any slope in the ground. The terms “upstream” and “downstream” are made with reference to the general direction of crop flow along the material conveyance systems described.

FIG. 1 illustrates in schematic form the main components of the crop processing system of a combine harvester 10 and will be used to explain the flow of material below. The crop processing system is shown in solid lines whilst the outline profile of harvester 10 is shown in ghost form.

Combine harvester 10, hereinafter referred to as ‘combine’, includes a chassis 12 supported on front wheels 14 and rear steerable wheels 16 which engage the ground 101. A driver's cab 18 is also supported on the chassis 12 and houses a driver's station from where a driver controls the combine 10.

A cutting header 20 is detachably supported on the front of a feeder house 22 which is pivotable about a transverse axis x to lift and lower the header 20 in a conventional manner.

The combine 10 is driven in a forward direction (arrow F) across a field of standing crop 102 in a known manner. The header 20 serves to cut and gather the standing crop material before conveying such as a crop material stream into feeder house 22. An elevator 24, normally in the form of a chain and slat conveyor or elevator as shown, is housed within the feeder house 22 and serves to convey the crop material stream upwardly and rearwardly from the header 20 to the crop processor designated generally at 26. At this stage the crop material stream is unprocessed.

The crop processor 26 of the illustrated combine 10 includes a pair of axial flow threshing and separating rotors 28 fed by a tangential flow, crop material impelling, feed beater 30. It should be appreciated however that alternative types of crop processor may be used without deviating from the scope of the invention. For example, the crop processor may instead include a conventional tangential flow threshing cylinder with a plurality of straw walkers for separation. Alternatively, a single axial-flow processing rotor may be employed.

Turning back to FIG. 1, the feed beater 30 rotates on a transverse axis and comprises crop engaging deflectors (not shown) which convey the crop material stream under the beater and into rotor housings 32 which each house one of said rotors 28. It should be appreciated that only the left-hand rotor 28 and housing 32 is shown in FIG. 1 whereas the right-hand equivalent is hidden from view.

The rotors 28 are positioned to have a generally longitudinal, or fore and aft, rotation axis which is normally inclined upwardly towards the rear of the combine 10.

Flighting elements (not shown) provided on the front end of each rotor 28 engage the crop material stream which is then conveyed as a ribbon or mat 103 in a generally rearward axial and helical path in the space between the rotor 28 and the rotor housing 32.

The axial flow rotors 28 serve to thresh the crop stream in a front region, separate the grain therefrom in a rear region, and eject the straw residue via a straw discharge chute 34 provided below a rear portion of the threshing rotors 28, the straw falling either directly onto the ground in a windrow, or to a crop residue spreader arrangement to be described in more detail below.

A part-cylindrical grate 37 provided in the underside of each rotor housing 32 allows the separated material to fall by gravity onto either a return pan 38 located below a rear section of the processor 26, or directly onto a stratification pan 40 located below a front section of the processor 26. In practice, the separated material falling through the grate 37 is typically a mix of grain and material other than grain (MOG) which may include chaff, tailings and some straw.

The return pan 38 and stratification pan 40 together serve as a material conveyance system arranged to convey the separated crop material to a grain cleaning shoe designated generally at 42. The pans 38, 40 each include a respective linkage (not shown) to convert a torque source into oscillating motion to oscillate the pans in a generally fore and aft direction. Combined with a transversely rippled or corrugated floor, the oscillating movement of the return pan 38 and stratification pan 40 propels the material generally forwardly or rearwardly respectively.

The return pan 38 “returns” the separated material incident thereon towards the front of the combine 10 (in the direction F) to a front discharge edge 44 from where the material falls or cascades onto the stratification pan 40. The material on the stratification pan 40 is conveyed rearwardly to a rear discharge edge 46 from where the material falls into the cleaning system or “shoe” 42.

The grain-MOG mix falls from the rear discharge edge 46 into the cleaning shoe 42 where the cascading mix is subjected to a cleaning airstream generated by fan 48, before falling onto the front of upper sieve or chaffer 50.

Chaffer 50 comprises adjustable louvres supported on a frame which is driven in fore-and-aft oscillating manner. The material which settles on the chaffer 50 is conveyed in a generally rearward direction and the heavier smaller grain-rich material passes between the louvres onto an underlying lower sieve 52, whereas the lighter larger material (mostly chaff) passes to the end of the chaffer and out of the rear of the machine at shoe outlet 54. A rear section of chaffer 50a is commonly independently adjustable and is configurable to allow tailings to pass there through into a re-threshing region 56 from where the tailings are conveyed via a re-threshing auger 58 back to the processor 26.

Lower sieve 52 is also driven in an oscillating manner to convey the collected grain-MOG mix rearwardly wherein the material falling there through is collected by a clean grain auger 60 for conveyance to an elevator (not shown) for onward conveyance to a grain tank 62. Material which does not pass through lower sieve 52 and is instead conveyed off the rear edge thereof falls into re-threshing region 56 for subsequent re-threshing.

The airstream generated by fan unit 48 is also conveyed by ducting up through lower sieve 52 and chaffer 50 to encourage lifting of the MOG from the chaffer surface.

For completeness the combine 10 includes an unloading system which includes an unloading auger 64.

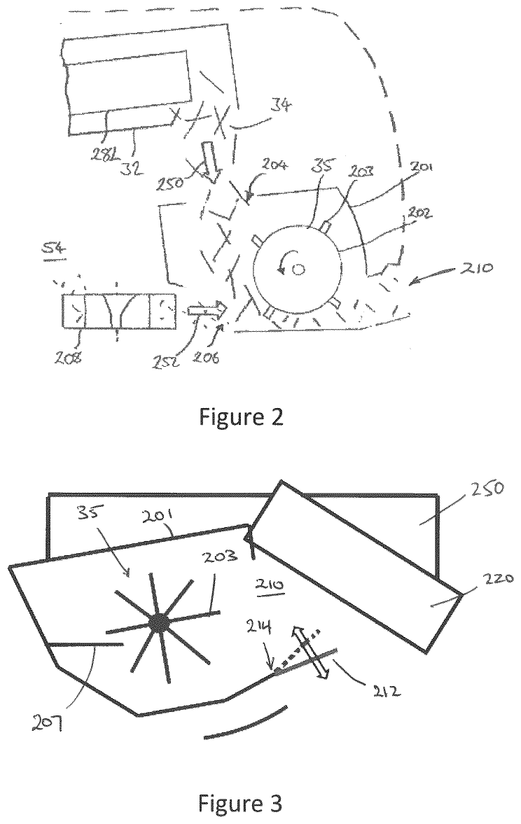

Aspects of the invention relate to the handling of the crop residue ejected by the straw or residue chopper 35. FIG. 2 shows the passage of straw dropped by the processing rotors 28 and of the chaff from the shoe outlet 54.

The straw or residue chopper 35 has a housing 201 inside which a chopper drum 202 is journaled for rotation on a transverse axis. The chopper drum 202 has sets of knives 203 pivotally mounted to the circumferential surface, the knives 203 interacting with stationary knives 207 (cf FIG. 3) to chop the threshed crop residue. An upper part of the housing 201 is formed with a first inlet 204 for reception of threshed crop residue (usually and mostly straw) falling from the rear of crop processing rotors 28L, 28R, indicated by arrow 250. Whilst it should be appreciated that only the left-hand rotor 28L can be seen in FIG. 2, both rotors 28L, 28R can be viewed from above in FIG. 3.

A front region of the housing 201 is optionally provided with a second inlet 206 for reception of chaff either directly from the shoe outlet 54 or via a chaff spreader 208 as is known in the art, for example as disclosed in U.S. Pat. No. 6,908,379. The movement of chaff from chaff spreader 208 through the second inlet 206 is indicated by arrow 252.

The residue entering the housing 201 is conveyed tangentially around and under the chopper drum 202, is chopped by the knives 203, and is expelled through an elongate transverse outlet 210 provided in a rear lower region of the housing 201.

A lower lip or edge of the outlet 210 is adjustable about a pivot axis 214 to provide a pivoting crop guide 212 (FIG. 3). As can be seen the pivot axis extends horizontally allowing for movement of the crop guide 212 between a lowered position (unbroken lines in FIG. 3) and a raised position (broken lines in FIG. 3).

Movement of the crop guide 212 may be achieved by the use of a suitable actuator 216. The driver's cab 18 includes a user terminal 218 from where a driver controls operation of the combine 10. A processor 219 (or a plurality of connected processors) receives signals from the user terminal 218 and interprets these signals to operate functions of the combine. One such signal received by the processor 219 may be used to control the actuator 216 and so operation of the pivoting crop guide 212. The electrical components may be connected for communication across any suitable network 217.

The residue is directed from the transverse outlet 210 toward counter rotating left- and right-hand residue spreader wheels 220, 222.

Each residue spreader wheel 220, 222 comprises a driven rotatable vane rotating around an axis. As shown schematically in FIG. 3 the residue spreader wheels 220, 222 are mounted at a downwardly inclined angle with respect to the straw or residue chopper 35. The axis of each residue spreader wheel can be seen to be inclined at around 30 degrees to the vertical. The residue spreader wheels 220, 222 are conveniently mounted to a frame 250. The frame 250 may be connected to the chassis 12 of the combine 10 in any suitable manner.

Chopped crop residue exiting through the chopper outlet 210 is thrown up against the underside of the residue spreader wheels 220, 222 and from which the chopped residue is directed in a generally rearward direction of flow out behind the combine harvester 10 on to the ground 101.

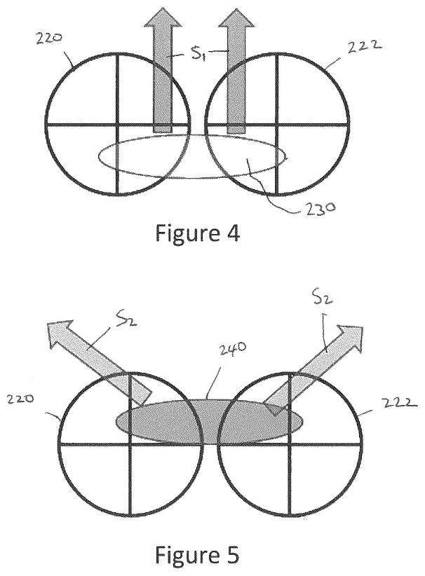

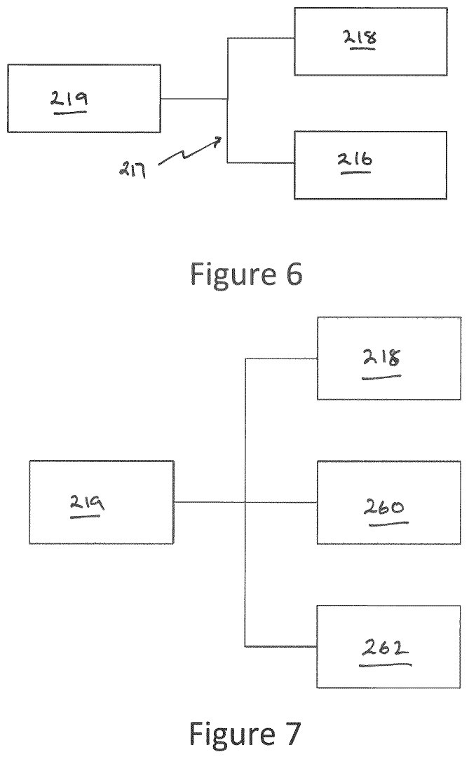

With the pivoting crop guide 212 in the lowered position (unbroken line in FIG. 3), the crop residue is directed to impinge on an area 230 of a lower portion of the rotating residue spreader wheels 220, 222 and the crop residue is spread narrowly substantially directly behind the combine 10 (arrows S₁—FIG. 4).

With the pivoting crop guide 212 in the raised position (broken line in FIG. 3), the crop residue is directed to impinge on an area 240 of a lower portion of the rotating residue spreader wheels 220, 222 and the crop residue is spread more broadly behind the combine 10 (arrows S₂ FIG. 5).

It can be seen that the degree of spreading is determined by a position of the pivoting crop guide 212 and accordingly by providing suitable operation of the user terminal 218 and operator can control the desired degree of spreading of the crop residue without changing the speed of operation of the rotating residue spreader wheels 220, 222.

It can be seen that only control of the pivoting crop guide is required to control the degree of spreading. Further due to the angle of the rotating residue spreader wheels 220, 222 the distributed crop residue is distributed at a better angle to penetrate crop stubble remaining in the ground. Additionally, due to the greater wrap angle on the chopper, there is a better chop quality to the spread crop residue.

In known arrangements, the crop residue is typically directed into a horizontally arranged pair of rotating residue spreader wheels 220, 222. By mounting the rotating residue spreader wheels 220, 222 above the chopper outlet 210, the crop residue is introduced to the rotating residue spreader wheels 220, 222 at a greater height such that there is a higher starting point to the distribution of the crop residue. This enables a better angle of discharge for the crop residue allowing the crop residue to better penetrate stubble on the ground.

Further, this arrangement allows for a minimal, or no, back wall on the chopper housing, meaning that the chopper is less likely to become plugged and that better access is provided for servicing of the chopper.

In a further example, the pivoting crop guide 212 comprises a first right hand portion and a second right hand portion. Each of the right- and left-hand portions of the pivoting crop guide is provided with an associated actuator 260, 262 (FIG. 7). Each actuator 260, 262 may be independently operable by the processor 219 in response to signals from the user in order to adjust the position of each of the right- and left-hand portions of the pivoting crop guide and so set independent feeding points of the crop residue from the residue chopper 35 to each of the counter rotating residue spreader wheels 220, 222. In this way an operator can achieve a desired residue spread to each side of the combine 10.

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of combine harvesters and component parts therefore and which may be used instead of or in addition to features already described herein.

What is claimed is:

1. A crop residue spreader arrangement comprising a frame, a pair of counter rotating residue spreader wheels carried from the frame, a residue chopper comprising an inlet, an outlet and a plurality of chopping blades between the inlet and the outlet, characterised in that the pair of counter rotating residue spreader wheels are arranged at a downwardly inclined angle with respect to the outlet of the residue chopper and in that the outlet of the residue chopper comprises an adjustable portion adjustable between a lowered position and a raised position to set a feeding point of the crop residue from the residue chopper to the counter rotating residue spreader wheels.

2. A crop residue spreader arrangement according to claim 1, wherein the adjustable portion comprises independently operable left- and right-hand side portions to set feeding points of the crop residue from the residue chopper to each of the counter rotating residue spreader wheels.

3. An agricultural harvester comprising a chassis and a crop residue spreader arrangement according to claim 1 carried by said chassis at a rear of the agricultural harvester.
